(19) United States
(12) Patent Application Publication
(10) Pub. No.: US 2023/0098168 A1
(43) Pub. Date: Mar. 30, 2023

(54) MOTOR VEHICLE CLOSING DEVICE

(71) Applicant: Kiekert AG, Heiligenhaus (DE)

(72) Inventor: Ulrich WEICHSEL, Duisburg (DE)

(21) Appl. No.: 17/799,044

(22) PCT Filed: Jan. 19, 2021
(86) PCT No.: PCT/DE2021/100057

§ 371 Date: Aug. 11, 2022

(30) Foreign Application Priority Data
Feb. 19, 2020 (DE) 10 2020 104 297.3

(51) Int. Cl. E05B 81/68; E05B 17/22; G01B 7/00; G01D 5/14

(52) U.S. Cl. CPC E05B 81/68; E05B 17/22; G01B 7/003; G01D 5/14

(57) ABSTRACT

A motor vehicle closing device, which is provided with at least one closing element, e.g. a rotary latch and/or a pawl as components of a motor vehicle lock. At least one sensor unit is also provided, which detects movements of the closing element. According to the invention, the sensor unit is designed for three-dimensionally detecting the movements of the closing element.

The invention relates to a motor vehicle closing device having at least one closing element, for example a rotary latch and/or a pawl as components of a motor vehicle lock, and having at least one sensor unit, which detects movements of the closing element.

The exact determination of the movement of closing elements and, in particular, the assumption of certain and predetermined positions is of particular importance, in particular in connection with motor vehicle locks, which include not only motor vehicle side door locks but also motor vehicle tailgate locks, motor vehicle front hoods locks and motor vehicle locks on seats, tank flaps, loading flaps, etc. In fact, for example, the function of a closing drive depends on a rotary latch as a closing element having assumed the pre-ratchet position thereof. In addition, the function of the closing drive is linked to the rotary latch safely reaching or having reached the main ratchet position after a closing process.

In addition to such comfort functions, however, safety functions in particular are also linked to perfect position sensing. The assumption of the main ratchet position by the rotary latch not only corresponds to the assumption of functional positions such as “locked,” “anti-theft” or “child-proof”, but the function of airbags or belt restraint devices is also linked thereto, for example. This means that reliable position sensing of the relevant closing element is of increasing and paramount importance in motor vehicle closing devices with regard to existing comfort and safety requirements.

In addition to the switches used at this point in the prior art, and in particular microswitches for position sensing, Hall sensors have also been used for a long time, as already described in WO 99/49159 A1. In fact, a rotary latch sensor and a pawl sensor are implemented at this point, on the one hand to detect the position of the rotary latch and on the other hand to detect the position of the pawl.

A control logic is also provided, with the help of which the individual signals coming from the two sensors can be evaluated together. For example, the open position of an associated motor vehicle door is linked to the fact that both sensors do not respond. Of course, other combinatorial evaluations are also possible. Hall sensors responding to co-moving permanent magnets are used as sensors.

The further and also relevant and generic prior art according to DE 196 43 947 A1 also works with a Hall sensor. In fact, the present case concerns a closure device for a motor vehicle door having a motor vehicle door lock and an associated lock holder. In this case, the rotary latch is made of a ferromagnetic material. In addition, the rotary latch controls at least one Hall sensor chip with an electronic switching function and corresponding conductor outputs. For this purpose, the Hall sensor chip can be arranged in a lock holder web.

The prior art has proven successful when it comes to sensing individual positions of motor vehicle closing elements at certain points, for example when the rotary latch has reached the pre-ratchet position or the main ratchet position. As the prior art according to WO 99/49159 A1 in particular makes clear, a plurality of sensor units have so far been used for this purpose, for example the rotary latch sensor described there and, in addition, the pawl sensor. This is complex. In addition, an increased number of sensors and their monitoring by a control unit, including signal evaluation, is prone to errors or indifferent functional states can occur. In extreme cases, this leads to error messages that are ultimately also caused by contamination but also by tolerances in the production of the respective closing elements. The invention as a whole seeks to remedy this.

The invention is based on the technical problem of further developing such a motor vehicle closing device in such a way that the technological complexity is reduced while the information density remains the same or is even increased.

To solve this technical problem, a generic motor vehicle closing device is characterized within the scope of the invention in that the sensor unit is designed for three-dimensionally detecting the movements of the closing element.

According to the invention, a special sensor unit is therefore used, namely one that not only allows the movement of the relevant closing element to be detected practically at points, but also spatially detects the movement in question of the closing element in the detection range of the sensor unit. As a result, a control unit that evaluates signals of the sensor unit can not only draw conclusions in the sense of “rotary latch in pre-ratchet position” or “rotary latch in main ratchet position,” but can also, for example, monitor the entire path of the rotary latch from the pre-ratchet position to the main ratchet position.

As a result, this measured path of the rotary latch can not only be monitored in the example given, but can also be compared by the control unit, for example, with setpoint values or threshold values stored therein and compliance therewith can be determined. As a result, it is now possible to draw conclusions such as whether or not, in the example under consideration, the rotary latch has been completely transferred from its pre-ratchet position to the main ratchet position using a closing drive. If the path in question that has been traveled is, for example, below a target path stored in the control unit, this indicates an incomplete closing movement. This in turn could be related to a malfunction of the closing drive, but in any case it ultimately means that the rotary latch has not reached its main ratchet position. As a result of this, for example, an associated motor vehicle door cannot be locked and associated safety devices cannot assume their function, which can be made transparent to an operator by means of corresponding displays in the cockpit.

It is clear that by using the specially designed sensor unit for three-dimensionally detecting the movements of the closing element, the information density that can be derived from signals of the sensor unit in question with the help of the control unit has increased significantly compared to the prior art. Because in addition to the detection at points of individual positions of the relevant closing element, the actuation path thereof can also be detected, for example. In addition, speeds of the relevant closing element can also be derived from the signals of the sensor unit. Acceleration of the closing element along its actuation path can also be detected and evaluated in this way. In connection with the above-mentioned compliance with threshold values or the comparison with setpoint values, an unprecedented wealth of information is available according to the invention that improves functionality in particular in conjunction with comfort and safety requirements. This is also and especially true against the background that the number of previous sensors can be reduced in this way, such that indifferent functional states practically no longer occur. Finally, using the sensor unit that works three-dimensionally, it is generally also possible to monitor a plurality of closing elements simultaneously with regard to their movements and, if necessary, to separate the movements from one another. The substantial advantages can be seen here.

According to one advantageous embodiment, the sensor unit works without contact. In principle, however, the sensor unit can also work in a tactile manner. As a rule, the sensor unit consists of a sensing element and a sensor. The sensing element can be attached on or in the closing element. Alternatively or additionally, however, the sensing element can also completely or partially coincide with the closing element.

The sensing element and the sensor can work optically. In this case, the sensing element can be a reflective surface with markings on the closing element, the position and movement of which is scanned, for example, by a light beam as a component of the sensor, which light beam, after being reflected by the sensing element, is evaluated by an associated receiver as a further component of the sensor. As a rule, the sensor is equipped in two parts with a lateral sensor element and a vertical sensor element. When applied to the specific case of the sensor unit that works optically, this means that the sensor element that works laterally detects movements of the sensing element in the lateral direction in relation to the lateral sensor element. In contrast, the vertical sensor element is designed to detect movements of the sensing element in the vertical direction compared to the sensor. When applied to the specific case of the sensing element that is equipped with markings and optically scanned, this means that, for example, points or structures are optically enlarged or reduced, as it were.

As a rule, however, the sensor unit works without contact and magnetically or inductively. In this case, the sensing element is designed as at least one permanent magnet, the three-dimensional movements of which are detected in this case by a three-dimensionally acting Hall sensor as a sensor. Such Hall sensors that work three-dimensionally again have a lateral sensor element and a vertical sensor element. Because the sensor in question is, as a rule, optionally arranged on a semiconductor chip together with other electronic components, the lateral sensor element corresponds to the measurement of a magnetic flux generated by the permanent magnet as a sensing element or the magnetic flux density perpendicular to the surface of the semiconductor chip. In contrast, the vertical sensor element is designed in such a way that it can be used to measure the magnetic flux density in question of the permanent magnet parallel to the surface of the semiconductor chip.

Because a plurality of permanent magnets and a plurality of Hall sensors that work three-dimensionally are also regularly used, the movement of the closing element monitored in this way can overall be detected three-dimensionally within the detection range of the sensor unit.

A similar and comparable design is, of course, just as conceivable for the case in which the sensor unit works without contact and optically. In this case, for example, a plurality of sensing elements and a plurality of optical sensors that work three-dimensionally can again be implemented. In any case, as with the sensor unit that works magnetically, the movement of the closing element within the detection range of the sensor unit can be detected and the signals can be evaluated using the connected control unit.

With regard to three-dimensional Hall sensors and correspondingly constructed sensor units, reference is made to DE 10 2012 203 225 A1, which concerns a method for non-contact measurement of a relative position using a 3D Hall sensor having a measurement signal memory, for further details on the mode of operation.

The subject matter of the invention is also a motor vehicle lock that is equipped with a motor vehicle closing device of the construction described at the outset. In any case, the sensor unit designed according to the invention for three-dimensional detection ensures that comprehensive and intelligent monitoring of the movements of the respective closing element is possible. The fact that both the lateral sensor element and the vertical sensor element are, as a rule, arranged on the semiconductor chip, optionally together with other electronic components, also means that costs can be kept low. In fact, such Hall sensors are usually equipped with a plurality of both lateral and vertical sensor elements that are typically arranged point-symmetrically around a central point. It is also possible to work with a plurality of uniaxial Hall sensors in order to directly measure all three components of the magnetic field in this way, as generated by the one or more permanent magnets on or in the closing element during its movement.

As a result, a three-dimensional vector of the magnetic flux density and thus the three-dimensional position of the closing element can be detected at any time using in particular the magnetic sensor unit that works three-dimensionally. If one considers a plurality of these vectors or corresponding end points, the desired conclusions about the movement of the closing element can be drawn from this, the movement also permitting conclusions about the speed of the closing element or even its acceleration by means of differentiation over time. The substantial advantages can be seen here.

The invention is explained in greater detail below with reference to drawings, which show only one example of an embodiment. In the drawings:

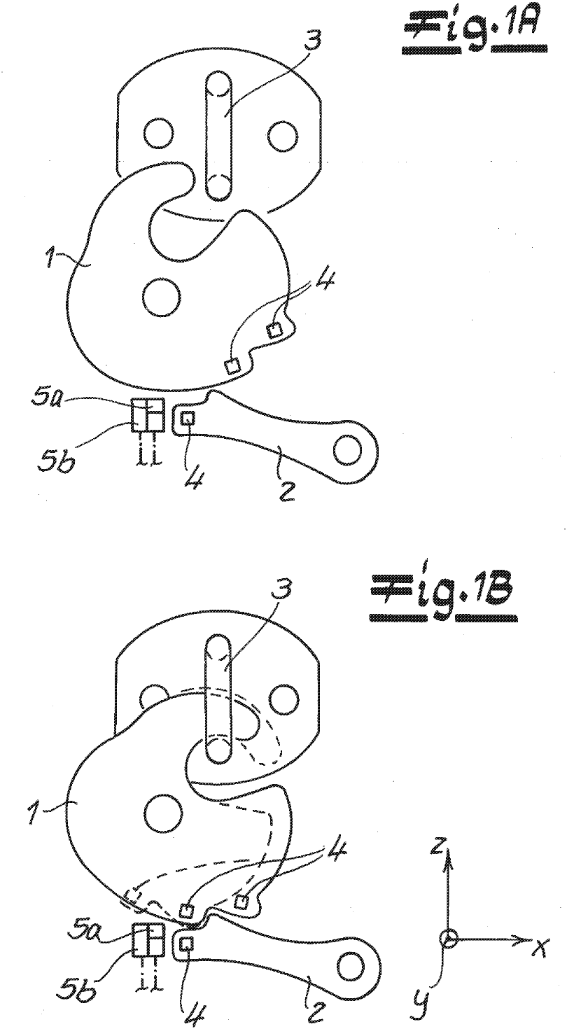

FIGS. 1A, 1B show the motor vehicle closing device according to the invention during the transition from an open position (FIG. 1A) into a pre-ratchet position and the main ratchet position indicated by dashed lines (FIG. 1B) and

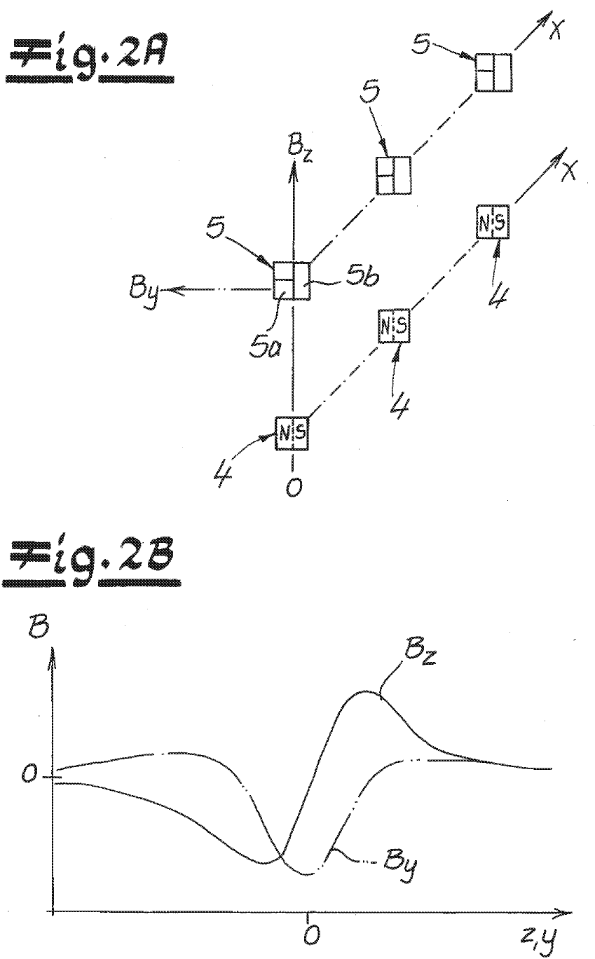

FIGS. 2A, 2B schematically show the sensor unit in detail (FIG. 2A) and a signal on the output side (FIG. 2B).

In the drawings, a motor vehicle closing device is shown. According to the embodiment and not by way of limitation, the motor vehicle closing device is part of a motor vehicle lock and is equipped with at least one closing element 1, 2 for this purpose. In fact, two closing elements 1, 2 are implemented according to the embodiment, namely a rotary latch 1 and a pawl 2 that together define a locking mechanism 1, 2 that interacts with a lock holder 3 in a known manner during a closing process of an associated motor vehicle door. For this purpose, the two closing elements 1, 2 are arranged in or on the relevant motor vehicle door, whereas the lock holder 3 is located on the body side.

A sensor unit 4, 5 or 4 implemented according to the invention is also of particular importance; 5a, 5b. According to the embodiment and according to the invention, the sensor unit 4, 5 is designed for three-dimensionally detecting the movements of the closing element 1, 2. The embodiment shows that in the present case the sensor unit 4, 5 detects both movements of the rotary latch 1 and movements of the pawl 2 in three dimensions. In principle, however, a plurality of sensor units 4, 5 can also be implemented for this purpose.

The sensor unit 4, 5 operates overall without contact and, according to the embodiment, has at least one sensing element 4 and a sensor 5 or 5a, 5b. According to the embodiment, a plurality of sensing elements 4 are implemented, namely two sensing elements 4 on the rotary latch 1 and a further, third sensing element 4 on or in the pawl 2. In the embodiment, the sensing elements 4 are each permanent magnets. In contrast, the sensor 5 or 5a, 5b is in the present case embodied as a 3D Hall sensor.

It can be seen that the sensor 5a, 5b is equipped in two parts with a lateral sensor element 5a and, in addition, a vertical sensor element 5b. It is clear from FIG. 2A that movements of the associated sensing element or the two sensing elements 4 in or on the rotary latch 1 in the X direction indicated there can be detected using the lateral or laterally detecting sensor element 5a. The X direction corresponds in the present case and not by way of limitation to the vehicle longitudinal direction. In addition, the lateral sensor element 5a is capable of optionally additionally recording movements of the relevant sensing element 4 in the Y direction or vehicle transverse direction. For this purpose, a plurality of sensors 5 arranged in the X direction and optionally in the Y direction can be provided, as indicated in FIG. 2A.

In contrast, the vertical sensor element 5b primarily ensures that, with its help, the movements of the sensing elements 4 in question on or in the rotary latch 1 are also detected in the Z direction or the vehicle vertical axis direction. According to the embodiment, the vertical sensor element 5b is additionally designed and able to sense pivoting movements of the pawl 2 and of the associated sensor 4 attached thereto or embedded therein in precisely this Z-direction.

In any case, signals for the magnetic flux density B in the Z direction Bz or also in the Y direction B_{Y} are observed schematically, as indicated in principle in FIG. 2B. Comparable signals that are not shown are registered for the X direction of the flux density Bx. These signals of the individual sensors 5 or the sensor elements 5a, 5b thereof can be recorded and evaluated by a control unit, which is not shown in detail. The control unit evaluates the signals of the sensor 5 not only to determine the position of the relevant closing element 1, 2. Rather, speeds of the relevant closing element 1, 2 or even the acceleration thereof can also be derived from this. Compliance with any threshold values or setpoint values during the movement of the closing element 1, 2 can also be checked using the control unit.

As a result, the control unit can check whether the rotary latch 1 has maintained a predetermined path, for example, starting from the open position in FIG. 1A in the transition to the pre-ratchet position according to FIG. 1B. Only then, in the example, is a closing drive acted upon by a corresponding signal of the control unit in order to move the rotary latch 1 from the pre-ratchet position according to FIG. 1B into the main ratchet position. The main ratchet position is shown in dashed lines in FIG. 1B.

The closing process has been successfully completed when, in the example under consideration, the rotary latch 1 has completed a path of 15 mm during the transition from the pre-ratchet position to the main ratchet position. If the path detected using the sensor unit 4, 5 and evaluated by the control unit is below this setpoint value, this indicates that the closing process is not complete. As a result of this, a signal is emitted, for example, that indicates that the main ratchet position has not been reached properly.

In addition, such comprehensive detection of the movement of the closing elements 1, 2 can also be used, for example, to activate safety devices such as airbags in the event that the rotary latch 1 in the example has not reached its main ratchet position but rather its pre-ratchet position according to the solid line in FIG. 1B. This increases safety enormously because, according to the invention, there is now the possibility of ensuring optimal protection for the vehicle passengers during operation and when the rotary latch 1 has not reached the main ratchet position.

### LIST OF REFERENCE SIGNS

1, 2 closing elements
3 lock holder
4, 5 sensor unit

1. A motor vehicle closing device comprising:
a motor vehicle lock having at least one closing element, and
a sensor unit which detects movements of the closing element, wherein the sensor unit is designed for three-dimensionally detecting the movements of the closing element.

2. The motor vehicle closing device according to claim 1, wherein the sensor unit works without contact with the closing element.

3. The motor vehicle closing device according to claim 1, wherein the sensor unit has a sensing element and a sensor.

4. The motor vehicle closing device according to claim 3, wherein the sensing element and the sensor work optically.

5. The motor vehicle closing device according to claim 3, wherein the sensing element includes a permanent magnet and the sensor includes a Hall sensor, and the sensing element and the sensor work inductively.

6. The motor vehicle closing device according to claim 3, wherein the sensing element is attached on or in the closing element .

7. The motor vehicle closing device according to claim 3, wherein the sensor includes a lateral sensor that detects movements of the closing element in a lateral direction and a vertical sensor that detects movements of the closing element in a vertical direction.

8. The motor vehicle closing device according to claim 3, wherein the sensor is arranged on a semiconductor chip .

9. The motor vehicle closing device according to claim 1, further comprising a control unit, wherein the sensor unit is connected to the control unit and the control unit evaluates the-signals of the sensor unit.

10. The motor vehicle closing device according to claim 9, wherein the control unit evaluates the signals of the sensor unit including one or more of position determination, speed, and acceleration of the closing element .

11. The motor vehicle closing device according to claim 3, wherein the sensing element entirely or partially coincides with the closing element.

12. The motor vehicle closing device according to claim 10, wherein the control unit evaluates the one or more of the position determination, speed, and acceleration of the closing element based on compliance with respect to at least one of a setpoint value and a threshold value.

13. The motor vehicle closing device according to claim 1, wherein the at least one closing element includes at least one of a rotary latch and a pawl.

14. The motor vehicle closing device according to claim 4, wherein the sensing element includes a reflective surface with markings on the closing element, and the sensor scans the sensing element with a light beam to detect the movements of the closing element.

15. The motor vehicle closing device according to claim 7, wherein the sensor includes a Hall sensor arrangement and the sensing element includes a permanent magnet, whereby the lateral sensor and the vertical sensor measure a magnetic flux generated by the permanent magnet.
